(19) United States
(12) Patent Application Publication
(10) Pub. No.: US 2009/0219534 A1
(43) Pub. Date: Sep. 3, 2009

(54) IMAGING DEVICE FOR SOLDER PASTE INSPECTION

(75) Inventor: PEI-CHONG TANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/354,676

(22) Filed: Jan. 15, 2009

(30) Foreign Application Priority Data
Feb. 28, 2008 (CN) 200810300423.X

(51) Int. Cl. G01J 3/46

(52) U.S. Cl. 356/425

(57) ABSTRACT

An exemplary imaging device for inspecting solder paste deposited on a printed circuit board includes a first light source, a second light source, and a camera. The first light source and the second light source are disposed adjacent to two different sides of the printed circuit board and above the printed circuit board. The first light source and the second light source project light with different colors onto the solder paste. The camera receives the light returned from the solder paste, constructs an image of the solder paste by converting the first light and the second light to electrical signals. The camera analyzes the image to identify defective portions in the solder paste based on color information and brightness information provided by the first light and the second light returned from the solder paste.

### BACKGROUND

1. Technical Field

The present disclosure generally relates to imaging devices, and particularly to an imaging device for inspecting solder paste deposited on a printed circuit board (PCB).

2. Description of Related Art

In the manufacture of PCBs, surface mounting components, such as resistors and capacitors, are commonly mounted on the PCBs using surface mount technology (SMT). SMT generally includes a solder pastes deposition process for depositing solder paste on conductive pads located on a PCB.

Manufacturing defects are common during the solder paste deposition process. If too much solder paste is deposited, one or more of the conductive pads on the PCB may make unwanted electrical connection with another nearby conductive pad on the PCB. If too little solder paste is deposited, only a poor mechanical and electrical connection might be established between one or more of the conductive pads on the PCB and the corresponding pads on surface mount components. Therefore, it is important to inspect the solder paste following the solder deposition process to determine whether the solder paste has been properly deposited.

One method of identifying defective solder paste uses a technology known as automated optical inspection (AOI). AOI technology generally utilizes a light source for perpendicularly projecting light beams on the solder paste, and a camera for capturing light beams reflected from the solder paste, thereby generating an image of the solder paste. Referring to FIG. 8, an image 10 of part of a sample PCB is illustrated. As seen, when the light beams are perpendicularly projected onto a patch of solder paste 106, a portion of the solder paste 106 such as the portion 102 is identified as defective.

However, as also seen, an image of the trace 104 is also captured. This can make it difficult to identify the defective portions of the solder paste 106.

Therefore, it is desired to provide an imaging device for reliably inspecting solder paste.

### BRIEF DESCRIPTION OF THE DRAWINGS

FIG. 1 is a side view of an imaging device in accordance with a first exemplary embodiment of the present invention, together with a sample PCB being inspected by the imaging device, wherein the imaging device comprises a camera and two light sources, and the PCB has a patch of solder paste thereon.

FIG. 2 is a top view of the light sources and the PCB of FIG. 1.

FIG. 3 is an enlarged view of one of the light sources and the patch of solder paste of FIG. 1.

FIG. 4 is an enlarged view of both of the light sources and the patch of solder paste of FIG. 1.

FIG. 5A is a first image of part of the PCB, obtained by using the imaging device of FIG. 1.

FIG. 5B is a second image of the same part of the PCB, obtained by using the imaging device of FIG. 1.

FIG. 6 is a top view of four light sources of an imaging device in accordance with a second exemplary embodiment of the present invention, together with a PCB being inspected by the imaging device.

FIG. 7 is a top view of three light sources of an imaging device in accordance with a third exemplary embodiment of the present invention, together with a PCB being inspected by the imaging device.

FIG. 8 is an image of the same part of the same sample PCB that was used in obtaining the images of FIGS. 5A and 5B, but obtained by using a related art imaging device.

### DETAILED DESCRIPTION

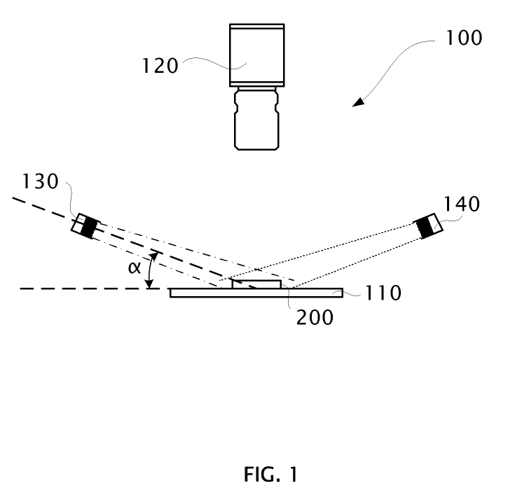

Referring to FIG. 1, an imaging device 100 in accordance with a first exemplary embodiment of the present invention is illustrated. The imaging device 100 is configured for capturing images of at least one patch of solder paste 200 deposited on a printed circuit board (PCB) 110, and analyzing the images to determine if the at least one patch of solder paste 200 has a defect or defects. In the illustrated embodiment, the PCB 110 is rectangular. In the following description, for simplicity, it will be assumed that there is only one patch of solder paste 200. In addition, for convenience, the patch of solder paste 200 will generally be referred to simply as “solder paste 200.” Furthermore, in the following description, a “defect” or “defects” may include at least one portion of the patch of solder paste 200 having too much solder, or too little solder, or solder irregularly distributed, or any combination of these defects.

The imaging device 100 generally includes a camera 120, and at least two light sources 130 and 140. The first light source 130 and the second light source 140 are capable of projecting light having different wavelengths onto the solder paste 200. In the present embodiment, the light is visible light, and the light having different wavelengths has different colors. The camera 120 is capable of receiving reflected and scattered light from the solder paste 200, converting the reflected and scattered light into electrical signals, and constructing an image by processing the electrical signals.

In the present embodiment, the first light source 130 and the second light source 140 utilize light emitting diodes (LEDs) to emit light. The first light source 130 and the second light source 140 are arranged symmetrically relative to the PCB 110, and at a predetermined distance above the solder paste 200, such that the light sources 130 and 140 can project the light at a predetermined angle α onto the solder paste 200. The predetermined angle α generally satisfies the following condition (1):

10°≦α≦45° (1)

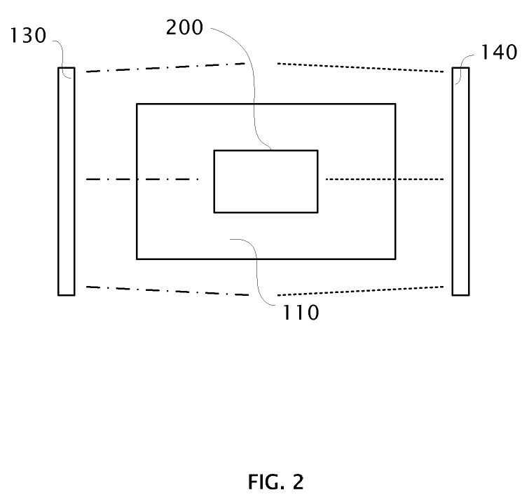

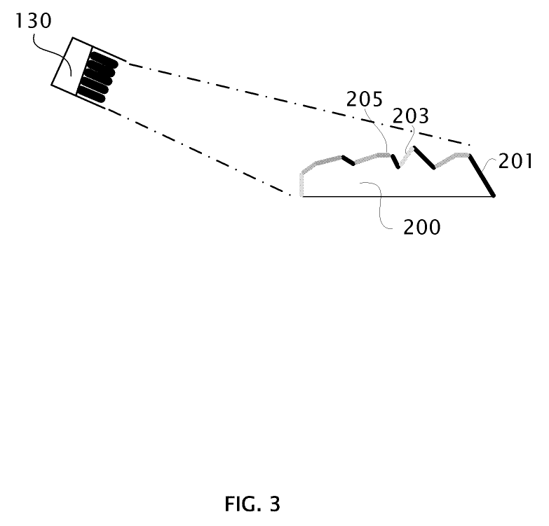

If the predetermined angle α is less than the lower limit of 10°, a large amount of the reflected and scattered light cannot be received by the camera 120; thus, a clear image generally cannot be constructed. Referring also to FIG. 3, if the predetermined angle α is larger than the upper limit of 45°, a downward slope 201 also may be able to receive the light projected from the first light source 130. If this happens, it may be difficult for the imaging device 100 to distinguish a defective portion from a normal portion in the image. Referring also to FIG. 2, the two light sources 130, 140 are strip-shaped, and are longer than a corresponding width of the PCB 110. Thereby, all the solder paste 200 on the PCB 110 can be sufficiently illuminated.

Referring to FIG. 3, this shows an enlarged side view of the solder paste in association with the first light source 130. Normally, when the solder paste is evenly distributed, an upper surface of the solder paste 200 is substantially flat. However, the upper surface of the solder paste 200 as shown in FIG. 3 is uneven and irregular. The solder paste 200 includes downward slopes 201 facing generally away from the first light source 130, upward slopes 203 facing generally toward the first light source 130, and flat surfaces 205.

When the first light source 130 projects light onto the solder paste 200, the projecting light only illuminates the upward slopes 203 and the flat surfaces 205 of the solder paste 200. That is, due to the predetermined angle of the first light source 130 relative to the solder paste 200, the light projected from the first light source 130 is unable to illuminate the downward slopes 201. As a result, the downward slopes 201 appear as shadows in the image taken by the camera 120, in respect of the reflected light originating from the first light source 130. That is, the brightness of the downward slopes 201 is less than that of the upward slopes 203 and the flat surfaces 205. Thereby, the camera 120 can analyze the image, and determine that the downward slopes 201 correspond to defective portions of the solder paste 200.

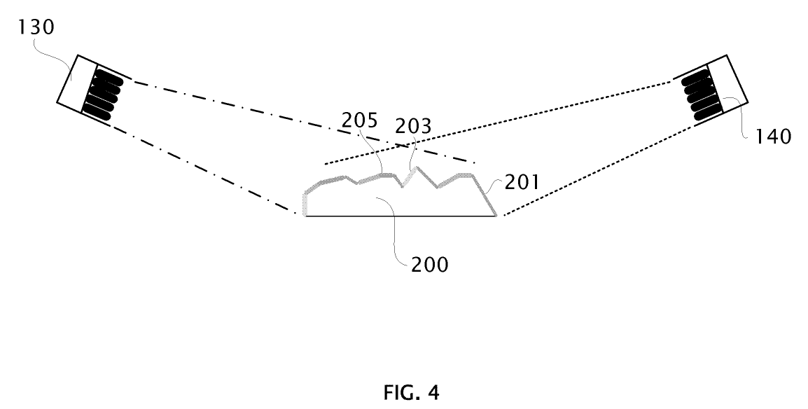

Also referring to FIG. 4, the first light source 130 and the second light source 140 may simultaneously project light having different wavelengths (colors) onto the solder paste 200. The two light sources 130, 140 are utilized to provide color information for analyzing the images captured by the camera 120. For example, the first light source 130 projects green light in a first direction onto the solder paste 200. The second light source 140 projects red light in a second direction onto the solder paste 200.

When the green light and the red light are simultaneously projected onto the solder paste 200, the green light can only illuminate the upward slopes 203 facing the first light source 130 and the flat surfaces 205, and the red light can only illuminate the downward slopes 201 facing the second light source 140 and the flat surfaces 205. As a result, at the flat surfaces 205, the green light and the red light are combined (mixed) together to generate yellow light according to color mixing theory in optics.

Therefore, the green light and the red light are reflected and scattered by the solder paste 200, and are received by the camera 120. The camera 120 can then construct an image to analyze the defective portions based on the color information. The downward slopes 201 are identified as defective portions, because the downward slopes 201 produce only red color information in the image. The upward slopes 203 are identified as defective portions, because the upward slopes 203 produce only green color information in the image. The flat surfaces 205 are identified as normal portions, because the flat surfaces 205 produce only yellow color information in the image. At the same time, the brightness information can also be used for identifying the defective portions. The brightness of the downward slopes 201 and the upward slopes 203 is less than that of the flat surfaces 205 in the image.

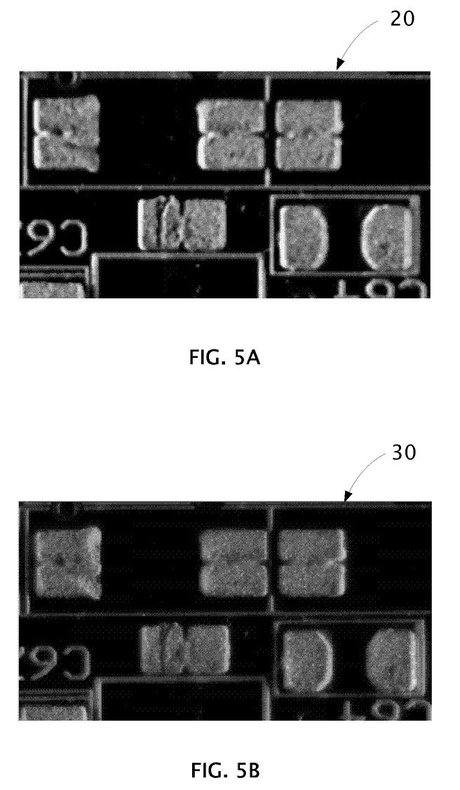

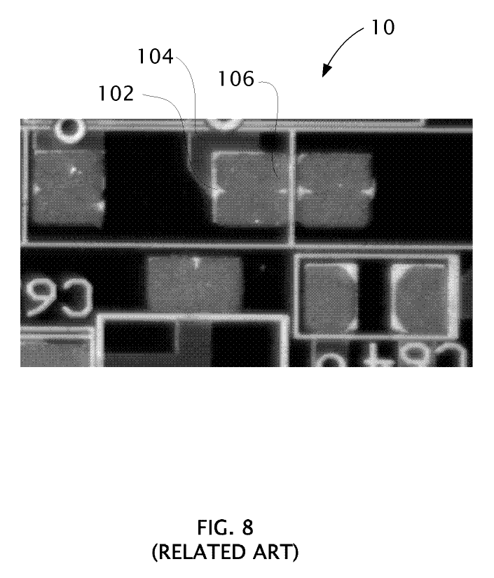

Referring to FIG. 5A and FIG. 5B, a first image 20 and a second image 30 are obtained by utilizing the present imaging device 100 arranged to have the predetermined angle α of 15° (see above). In particular, the first image 20 is obtained by projecting green light and red light from the first light source 130 and second light source 140, respectively, onto the solder paste 200. Of course, the first image 20 is a monochrome rendering of the original true color image obtained. The second image 30 is obtained by emitting blue light and red light from the first light source 130 and second light source 140, respectively, onto the solder paste 200. Of course, the second image 30 is a monochrome rendering of the original true color image obtained. As seen in the first image 20 and the second image 30, more defective portions are indentified than is the case with the image 10 obtained by the conventional imaging device (see above, and FIG. 8), because both color information and brightness information are utilized to analyze the defective portions. Furthermore, this advantageous identification of more defective portions is even manifest in the monochrome renderings that are the first and second images 20, 30.

As described above, unlike with a conventional imaging device for inspecting solder paste by perpendicularly projecting single-colored light, the present imaging device utilizes at least two light sources capable of projecting light with different colors at predetermined angles. The light sources are arranged at predetermined angles at two sides of the solder paste; thus, both color information and brightness information can be utilized for identifying defective portions of the solder paste. Moreover, traces on a printed circuit board typically have regular surfaces. This means all the light from the first and second light sources can illuminate and be reflected by the traces. As a result, the traces are identified as normal portions, and do not affect the results of inspecting the solder paste.

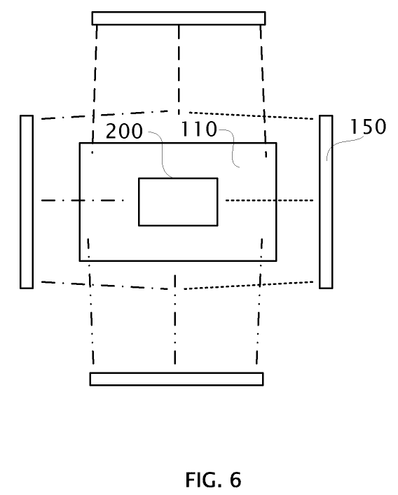

Referring to FIG. 6, this shows four light sources of an imaging device in accordance with a second exemplary embodiment of the present invention. The four light sources 150 are strip-shaped, and are arranged adjacent to four sides of the PCB 110 respectively. In particular, the four light sources 150 are arranged in two pairs. In each pair of light sources 150, the light sources 150 are arranged symmetrically with respect to each other across the PCB 110. The four light sources 150 may project light with at least two colors onto the solder paste 200 deposited on the PCB 110.

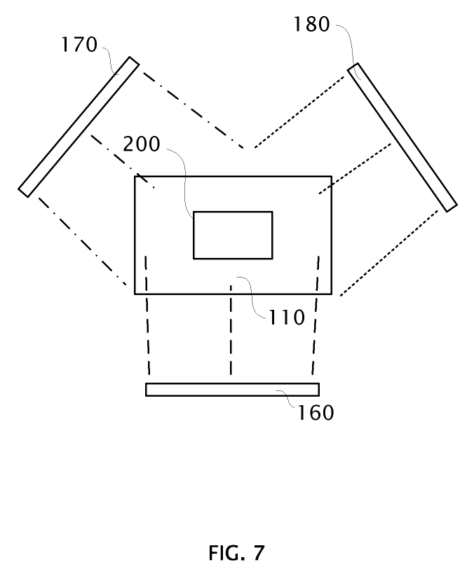

Referring to FIG. 7, this shows three light sources of an imaging device in accordance with a third exemplary embodiment of the present invention. The three light sources 160, 170, and 180 are strip-shaped, and are arranged generally radially symmetrically about the PCB 110. In the illustrated embodiment, the light source 160 is arranged parallel to one side of the PCB 110. The other two light sources 170, 180 are obliquely arranged with respect to the PCB 110. The three light sources 160, 170, and 180 may project light with at least two colors onto the solder paste 200 deposited on the PCB 110.

It is believed that the present embodiments and their advantages will be understood from the foregoing description, and it will be apparent that various changes may be made thereto without departing from the spirit and scope of the invention or sacrificing all of its material advantages.

What is claimed is:

1. An imaging device for inspecting solder paste on a printed circuit board, the imaging device comprising:
a first light source;
a second light source, the first light source and the second light source disposed adjacent to two different sides of the printed circuit board, the first light source capable of emitting light having a first color in a first direction to the solder paste on the printed circuit board, the second light source capable of emitting light having a second color in a second direction to the solder paste on the printed circuit board; and
a camera positioned for receiving the first color light and the second color light reflected from the solder paste, the camera configured for converting the received first color light and second color light to electrical signals, constructing an image of the solder paste according to the electrical signals, and analyzing the image to identify defective portions in the solder paste based on color information provided by the received first color light and second color light.

2. The imaging device according to claim 1, wherein the camera analyzes the image to indentify the defective portions in the solder paste based on the color information combined with brightness information also provided by the received first color light and second color light.

3. The imaging device according to claim 1, wherein the first light source and the second light source are substantially symmetrically arranged with respect to the printed circuit board.

4. The imaging device according to claim 1, wherein the first color light and the second color light are projected onto the solder paste on the printed circuit board at predetermined angles within a range of about 10° to about 45°.

5. The imaging device according to claim 1, wherein the first light source and the second light source utilize light emitting diode to project the first color light and the second color light onto the solder paste.

6. The imaging device according to claim 1, wherein the first light source and the second light source are strip-shaped, and have lengths larger than a corresponding width of the printed circuit board.

7. The imaging device according to claim 6, wherein the first light source and the second light source are arranged to be parallel to the two opposite sides of the printed circuit board.

8. The imaging device according to claim 6, further comprising:
a third light source and a fourth light source, the third light source and the fourth light source are arranged to be parallel to another two opposite sides of the printed circuit board.

9. The imaging device according to claim 6, wherein the first light source and the second light source are obliquely arranged with respect to the printed circuit board.

10. The imaging device according to claim 9, further comprising:
a third light source disposed adjacent to a side of the printed circuit board, such that the first, second and third light sources are arranged generally radially symmetrically about the printed circuit board.

11. The imaging device according to claim 10, wherein the first, second and third light sources are strip-shaped, and one of the first, second and third light sources is parallel to one side of the printed circuit board.

12. An imaging device for inspecting solder paste on a printed circuit board, the imaging device comprising:
a first light source capable of emitting light having a first color in a first predetermined direction to the solder paste on the printed circuit board;
a second light source capable of emitting light having a second color in a second predetermined direction to the solder paste on the printed circuit board; and
a camera positioned for receiving the first color light reflected from the solder paste and the second light reflected from the solder paste, and configured for converting the first color light and the second color light to electrical signals, and constructing an image of the solder paste according to the electrical signals;
wherein when a surface of the solder paste is irregular, at least one of the following conditions applies:
only a first portion of the image contains image information of the first color, and a remaining portion of the image is identified as an area corresponding to a defective portion of the solder paste; and
only a second portion of the image contains image information of the second color, and a remaining portion of the image is identified as an area corresponding to a defective portion of the solder paste.

13. The imaging device according to claim 12, wherein the first light source and the second light source are disposed adjacent to two opposite sides of the printed circuit board and higher than the printed circuit board.

14. The imaging device according to claim 12, wherein the first light source and the second light source utilize light emitting diode to project the first color light and the second color light.

15. An imaging device for inspecting solder paste on a printed circuit board, the imaging device comprising:
a first light source disposed adjacent to one side of the printed circuit board, and configured for projecting light having a first color to the solder paste;
a second light source disposed adjacent to another side of the printed circuit board, and configured for projecting light having a second color to the solder paste; and
a camera positioned for receiving the first light and the second light reflected from the solder paste, and configured for constructing an image of the solder paste based on the received first and second light, wherein a portion of the image containing a mixture of the first color light and the second color light corresponds to a portion of a surface of the solder paste which is substantially regular.

16. The imaging device according to claim 15, wherein the first light and the second light are projected at predetermined angles ranged between approximately about 10° and approximately about 45°.

17. The imaging device according to claim 15, wherein the first light source and the second light source are strip-shaped, and have lengths larger than a corresponding width of the printed circuit board.

18. The imaging device according to claim 15, wherein the first light source and the second light source are arranged to be parallel to two opposite sides of the printed circuit board.

19. The imaging device according to claim 18, further comprising:
a third light source and a fourth light source, the third light source and the fourth light source are arranged to be parallel to another two opposite sides of the printed circuit board.

20. The imaging device according to claim 15, further comprising:
a third light source disposed adjacent to a side of the printed circuit board, such that the first, second and third light sources are arranged generally radially symmetrically about the printed circuit board.
